(19) United States
(12) Patent Application Publication
(10) Pub. No.: US 2007/0280129 A1
(43) Pub. Date: Dec. 6, 2007

(54) System and method for calculating packet loss metric for no-reference video quality assessment

(76) Inventors: Huixing Jia, Beijing (CN); Xin-yu Ma, Beijing (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/638,656

(22) Filed: Dec. 12, 2006

(30) Foreign Application Priority Data
Jun. 6, 2006 (CN) 200610083357

(51) Int. Cl. H04J 1/16

(52) U.S. Cl. 370/252; 370/465

(57) ABSTRACT

A packet loss metric calculation system for a video stream includes an intercepting module to intercept a plurality of adjacent image frames in the video stream. A sampling module samples a plurality of pixel blocks in predetermined locations in each of the intercepted image frames. A detecting module detects the change of each of the sampled blocks over all intercepted image frames to determine whether there is an image quality decline in the block. A packet loss metric generator generates the packet loss metric based on the number of blocks detected by the detecting module to have image quality decline. Furthermore, a method for calculating packet loss metric of a video stream is also described.

### TECHNICAL FIELD

The technical field of the invention relates to no-reference video quality assessment and, in particular, to a system and method for calculating packet loss metric for the no-reference video quality assessment.

### BACKGROUND

Along with the development of video over Internet Protocol (IP) technologies, there has been growing emphasis on real-time assessment of digital video quality for various visual communication services. The methods for video quality assessment include subjective methods and objective methods. The subjective methods typically involve human assessors, who grade or score video quality based on their subjective feelings, and use the grades or scores obtained in such a subjective way for video quality assessment. The objective methods, on the other hand, do not involve human assessors and assess the video quality only by using information obtained from the video sequences.

The objective video quality assessment methods can be further classified into full-reference methods, reduced-reference methods, and no-reference (NR) methods. Both the full-reference methods and the reduced-reference methods need reference information about the original video (i.e. the video actually transmitted from the transmitting side) to conduct the video quality assessment and thus cannot be used for real-time in-service video quality assessment. On the other hand, the no-reference methods do not require the reference information of the original video. Instead, the NR methods make observations only on decoded video (i.e. the video that has been received and decoded on the receiving side) and estimate the video quality using only the observed information on the decoded video.

For an NR video quality assessment, two major sources of video quality decline should be taken into consideration. The first one is coding and compression of video sources and the second one is packet loss during transmission.

In an IP network, deterioration in perceived video quality is typically caused by packet loss. Most packet losses result from congestions in network nodes as more and more packets are dropped off by routers in IP networks when congestion occurs and the severity increases. The effect of packet loss is a major problem for real-time video transmission such as streaming video. The measurement of the video quality decline caused by packet loss during transmission is referred to as packet loss metric.

A number of prior methods for calculating the packet loss metric have been proposed. For example, one prior art technique detects artifacts along block edges to estimate the video distortion introduced in a given video frame by packet loss. Another prior art technique extracts spatial distortion of each image in a video stream using differences between corresponding regions of two adjacent frames in the video sequence. The spatial distortion is weighted based on temporal activities of the video, and the video quality is measured by detecting the spatial distortions of all images in the sequence.

However, the two aforementioned methods for calculating the packet loss metric need to process all the blocks in an image frame. Therefore, those methods are very computation intensive and are not suitable for use in real-time transmission applications.

### SUMMARY

A packet loss metric calculation system for a video stream includes an intercepting module to intercept a plurality of adjacent image frames in the video stream. A sampling module samples a plurality of pixel blocks in predetermined positions in each of the intercepted image frames. A detecting module detects the change of each of the sampled blocks over all intercepted image frames to determine whether there is an image quality decline in the block. A packet loss metric generator generates the packet loss metric based on the number of blocks detected by the detecting module to have image quality decline.

Furthermore, a method for calculating packet loss metric of a video stream includes the step of intercepting a plurality of adjacent image frames in the video stream. The method also includes the step of sampling a plurality of pixel blocks in predetermined locations in each of the intercepted image frames. The method further includes the step of detecting the change of each of the sampled blocks over the intercepted image frames to determine whether there is image quality decline in the block. The method then generates the packet loss metric of the image based on the number of blocks detected to have image quality decline.

### BRIEF DESCRIPTION OF THE DRAWINGS

The foregoing and other features of this invention may be more fully understood from the following description, when read together with the accompanying drawings in which:

FIG. 1 illustrates a block diagram of a packet loss metric calculation system for calculating the packet loss metric for no-reference video quality assessment implemented in accordance with an embodiment of the invention;

FIG. 2 is a schematic diagram of an example of the sampled pixel blocks in an image frame;

FIG. 3 is a block diagram of one example of the detecting module shown in FIG. 1;

FIG. 4 illustrates a flow chart diagram of the operation of the detecting module of FIG. 3;

FIG. 5 shows changes of a block over a plurality of adjacent image frames under different packet loss rates, wherein the horizontal axis represents the frame sequence and the vertical axis represents the change of the block between each frame and a previous frame; and

FIG. 6 is a flow chart diagram of a method for calculating the packet loss metric for no-reference video quality assessment implemented in accordance with an embodiment of the invention.

### DETAILED DESCRIPTION

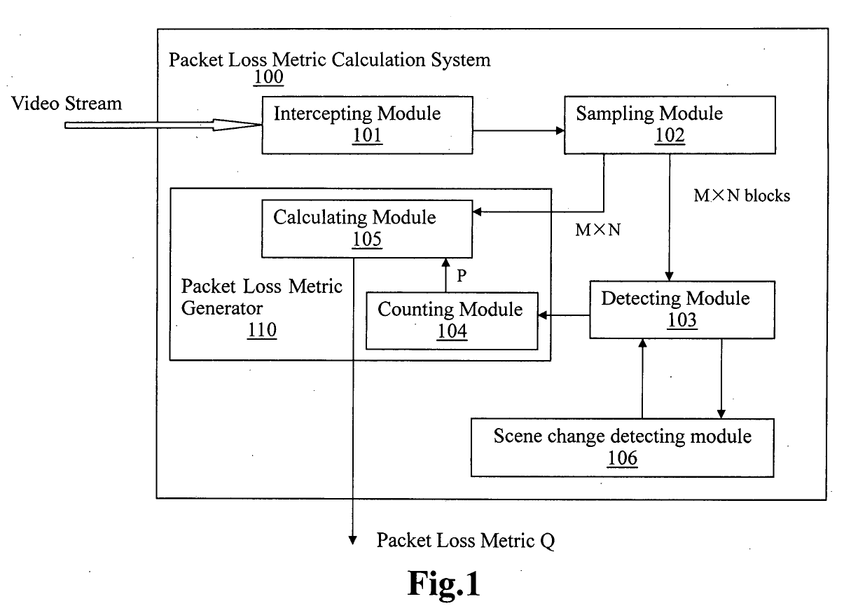

According to an embodiment of the present invention and as shown in FIG. 1, a packet loss metric calculation system 100 is provided to calculate the packet loss metric of a video stream for NR objective video quality assessment. Instead of processing the entire image area of an image frame to obtain or calculate the packet loss metric, the packet loss metric calculation system 100 only samples some blocks of the image frame to calculate the packet loss metric of that image frame. The present invention provides a compromise between accuracy and speed. In addition, it reduces the computation amount greatly and can be applied to real-time video measurement application.

In FIG. 1, the packet loss metric calculation system 100 includes an intercepting module 101, a sampling module 102, a detecting module 103, and a packet loss metric generator 110. In one embodiment, the packet loss metric generator 110 includes a counting module 104 and a calculating module 105. Furthermore, in another embodiment, the packet loss metric calculation system 100 optionally includes a scene change detecting module 106 to detect the existence of a scene change between adjacent frames.

The intercepting module 101 is employed to receive a video stream from a video source such as a video decoder (not shown) and to intercept L adjacent or consecutive image frames from the video stream. Here, L represents an integer with a value of greater than zero (e.g., 2, 3, . . . ). In one embodiment, the video decoder decodes video data received via a communication channel (not shown), and provides the decoded video stream to the packet loss metric calculation system 100. The intercepting module 101 intercepts L adjacent image frames from the decoded video stream. In one embodiment, the packet loss metric is calculated every t seconds. Suppose the rate of the video stream is f frames per second, then L=t×f. The structure and operation of the intercepting module 101 will not be described in more detail below as they can be realized in many known ways.

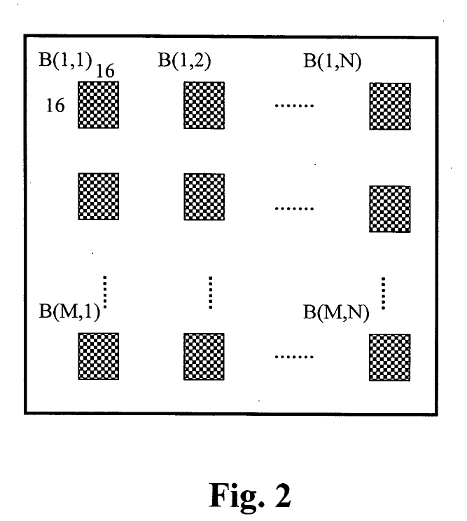

The L intercepted image frames are then sent to the sampling module 102, which samples a plurality of pixel blocks located in predetermined positions from each of the frames. In accordance with one embodiment of the present invention, only some pixel blocks in each intercepted image frame (rather than the entire image frame) are sampled by the sampling module 102. An example of the sampling of pixel blocks in predetermined locations in an image frame is shown in FIG. 2. The structure and operation of the sampling module 102 will not be described in more detail below as it can be realized in many known ways.

As can be seen from FIG. 2 as an example, M×N blocks forming a matrix in an intercepted image frame are sampled by the sampling module 102 of FIG. 1. Here, both M and N are integers and the value of M×N is less than the total number of blocks within the image frame. This allows only some pixel blocks within the image frame (rather than the entire image frame) to be sampled.

In one embodiment, the size of each block is the size of a macro block defined by the adopted video compression standard. Each macro block may have different number of pixels. For example, a macro block may include 16×16 pixels. In this case, the start position of each block represented in the unit of pixels should be correspondingly selected as multipliers of 16, that is, the position of each block corresponds to the position of a macro block. The selection of the sampled blocks, however, is not limited to an M×N matrix, but may be an arbitrarily scattered pattern. In addition, the size of each block is not limited to 16×16.

The pattern (i.e., the predetermined positions) in which the sampled blocks scatter in the entire image frame may be determined based on the availability of computational resources. When the blocks scatter all over the entire image frame, the measurement accuracy would be higher but the computation amount would also be higher. When the blocks are concentrated around the center of the image frame, the measurement accuracy will be lower but the amount of computation will also be lower. In addition, the number of blocks may be viewed as a compromise between accuracy and speed. The larger the number of blocks is, the higher the accuracy is, but with lower processing speed. The smaller the number of blocks is, the lower the accuracy is, but with higher processing speed. The block number, block size, and scatter pattern of the sampled blocks are not limited to the examples described herein. Rather, different block number, block size, and scatter pattern may be selected based on the availability of computational resources and the requirements for accuracy and speed.

However, once the block number, block size, and scatter pattern of the sampled blocks are determined, they are not changed among at least the L intercepted frames so that change in each of the sampled blocks over the L intercepted frames may be detected.

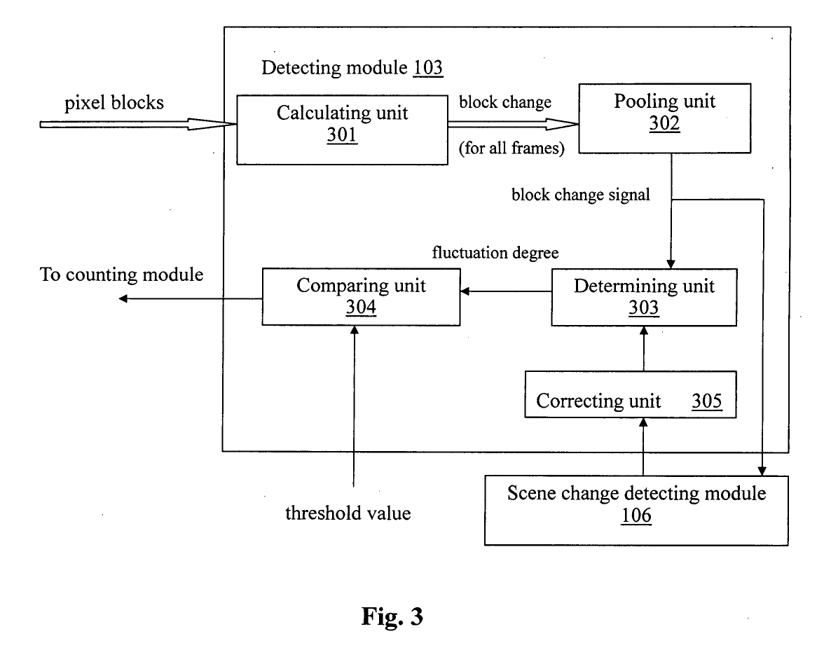

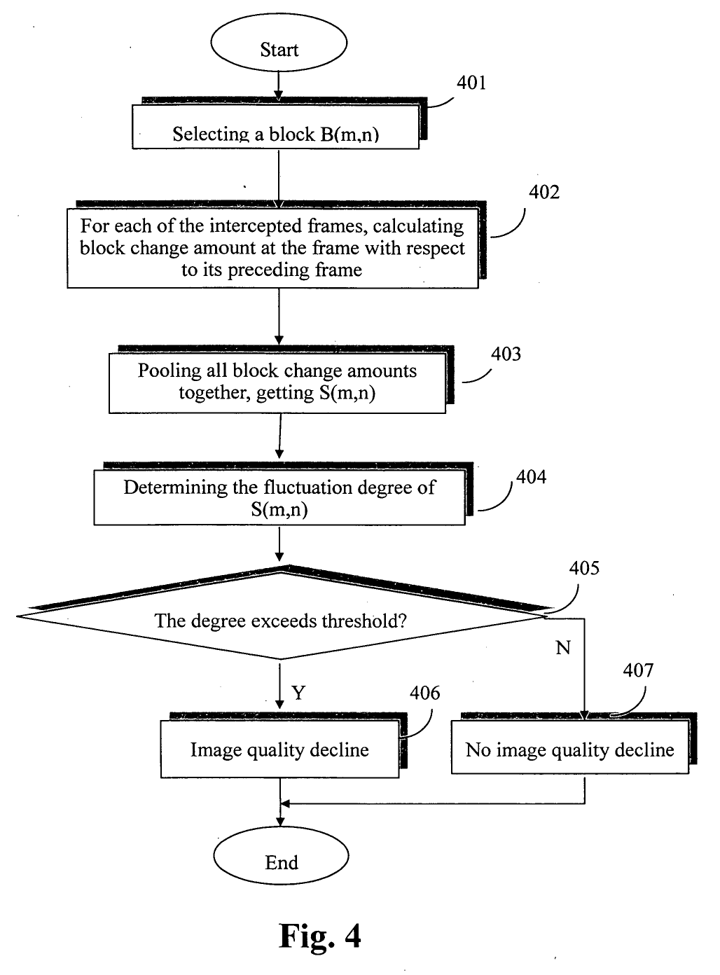

Referring back to FIG. 1, the pixel values of the sampled blocks are then sent from the sampling module 102 to the detecting module 103. The detecting module 103 detects the block change of each of the sampled blocks at each predetermined position over all other sampled blocks at the same predetermined position across the intercepted L image frames to determine whether there is image quality decline in those blocks due to packet losses during transmission. In one embodiment, the change of a sampled block at the predetermined position across the intercepted L frames is detected by comparing the fluctuation degree of the change between the sampled blocks of the intercepted L frames at that particular predetermined position with a predetermined threshold. One example of the detecting module 103 and its operation will be described below, along with reference to FIGS. 3-4.

Referring still to FIG. 1, although not shown, each module of the packet loss metric calculation system 100 may include a buffer for temporarily storing pixel data of the intercepted image frames and other relevant data. For example, the detecting module 103 may include a buffer for storing pixel values of each of sampled blocks. Alternatively, the packet loss metric calculation system 100 may include a main memory (not shown) in which memory locations are accessible by each module during operation.

In one embodiment, the block change amounts of each of the sampled blocks (not all the pixel values of each of the sampled blocks) are buffered by the detecting module 103, thereby reducing memory occupation or requirement. In other words, the detecting module 103 calculates differences of sampled pixel values between adjacent frames and buffers the calculated pixel value differences instead of the sampled pixel values per se.

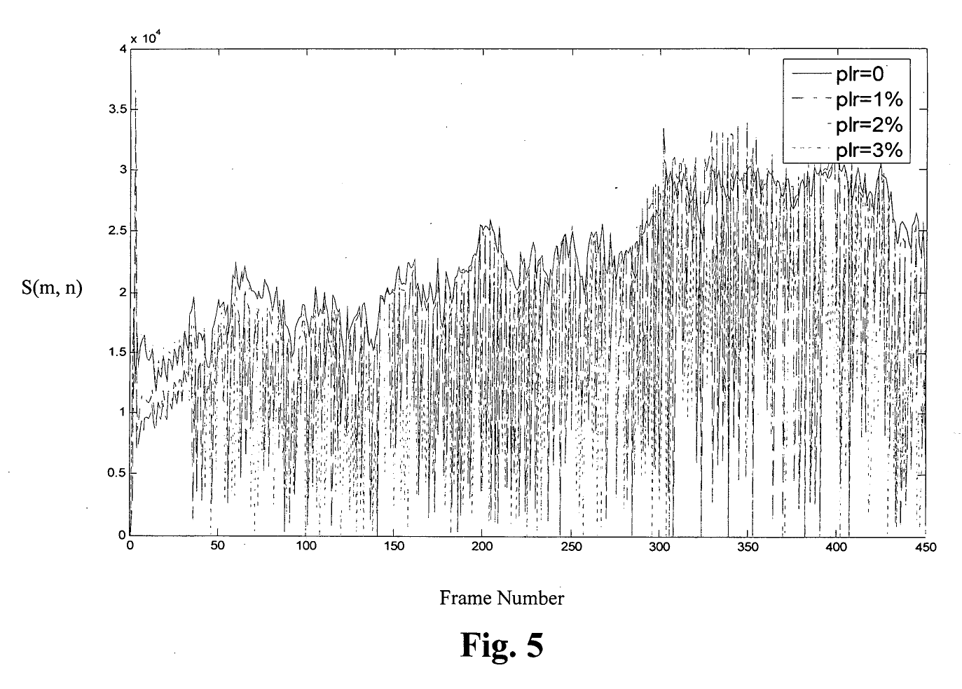

In one embodiment, the packet loss metric calculation system 100 further includes a scene change detecting module 106 to detect the existence of a scene change between adjacent frames. Here, it should be noted that the scene change has great negative effect on the packet loss metric calculation and needs to be eliminated. However, in the event that there is no scene change within the L intercepted image frames, e.g. with respect to a video stream captured by a still camera, the optional scene change detecting module 106 may be excluded from the system. The detailed description on the elimination of the scene change effect will be discussed below with reference to FIGS. 4 and 5.

Turning back to FIG. 1, the detecting results of the detecting module 103 for all samples blocks are subsequently sent to the packet loss metric generator 110 to generate a packet loss metric for the video stream. As described above, in one embodiment, the packet loss metric generator 110 includes a counting module 104 and a calculating module 105, and the packet loss metric is generated by calculating the ratio of the number of blocks with image quality decline within an image frame and the total number of the sampled blocks within that image frame. In this case, the detecting results are sent from the detecting module 103 to the counting module 104 to count the number of blocks within an image frame in which image quality decline is present. The count value of the counting module 104, i.e. the number of blocks having image quality decline is then sent to the calculating module 105 for calculating the packet loss metric. In one embodiment, the packet loss metric is expressed as the ratio of the number of the blocks having quality decline as detected by the detecting module 103 in one image frame to the total number of the sampled blocks in that image frame. Specifically, in the case that M×N blocks arranged in a matrix within an image frame are sampled by the sampling module 102, suppose P blocks are detected as experiencing image quality decline, Q=P/MN is calculated by the calculating module 105 as the packet loss metric. After that, the calculated packet loss metric Q is output from the packet loss metric calculation system 100. The packet loss metric Q may be fed into other objective video quality assessment schemes for further assessment. It should be noted, however, the operation of the packet loss metric generator 1 10 is not limited to the specific example described above, but any means for calculating the packet loss metric based on the detecting results of the detecting module 103 may be applied.

As described above, FIGS. 3-4 show the structure and operation of the detecting module 103. In FIG. 3, the detecting module 103 includes a calculating unit 301 to receive each of the sampled blocks and to calculate a block change amount for the received block among of the intercepted frames, which indicates the change between the block at one predetermined position within one image frame and another sampled block at the same predetermined position of a preceding image frame. The detecting module 103 also includes a pooling unit 302 to pool the block change amounts of each of the sampled blocks at the predetermined position of all intercepted image frames together to obtain a block change signal. The detecting module 103 also includes a determining unit 303 to determine the fluctuation degree of the block change signal and a comparing unit 304 to compare the fluctuation degree with a predetermined threshold value to determine whether there is image quality decline in the block. The comparison result is then sent to the counting module 104 of FIG. 1 to count the number of blocks in which image quality decline is present. Each of the calculating unit 301, the pooling unit 302, the determining unit 303, and the comparing unit 304 can be implemented in software, hardware, or firmware using known techniques. Thus, the structures of these components will not be described in more detail below.

As described above, the scene change may have great negative effect on the packet loss metric calculation, and thus an optional scene change detecting module 106 of FIG. 1 may be included in the system. In one embodiment, a correcting unit may be coupled between the scene change detecting module 106 and the determining unit 303 of the detecting module 103. As shown in FIG. 3, in the case of the scene change detecting module 106 being present, the block change signal is first provided from the pooling unit 302 to the scene change detecting module 106, in which scene change is detected. However, in the event that there is no scene change inside the L intercepted image frames, e.g. with respect to a video stream captured by a still camera, the scene change need not be detected and the block change signal from the pooling unit 302 may be provided to the determining unit 303 directly to determine the fluctuation degree. In the case that the scene change is detected, the points of the block change signal having detected the scene change are corrected in the correcting unit 305 to eliminate the effect of the scene change. The correction of the block change signal can be implemented by methods known in the art. One example of the methods will be described later. The corrected block change signal is provided to the determining unit 303 for further processing.

The detailed detecting operation of the detecting module 103 is shown in FIG.4. In FIG. 4, the process starts with 401, wherein one of the sampled blocks B(m, n) is selected. In the embodiment, block B(m, n) includes 16×16 pixels. The block B(m, n) is provided to the calculating unit 301 in FIG. 3. At 402, with respect to the L intercepted frames, the block change amount of block B(m, n) at each of the intercepted frames is calculated by the calculating unit 301. In an embodiment, the block change amount of block B(m, n) at one frame is calculated as the sum of the absolute values of the differences of every pixel values in the block B(m, n) between the frame and its preceding frame. In particular, the change amount of block B(m, n) at the ith frame with respect to the (i−1)th frame is calculated as S(m,n,i)=Sum(abs(Fi(B(m,n)−Fi−1(B(m,n)))), i=2, . . . L. In this equation, Fi(B(m,n)) is a matrix (16×16 in the embodiment), each element of which representing the pixel value of a pixel in block B(m, n) in the ith frame. S(m,n,i) is a value that equals to the sum of the absolute values of all the elements in the difference between matrices Fi(B(m,n)) and Fi−1(B(m,n)).

At 403, a block change signal S(m, n) can be obtained by pooling the change amounts S(m, n, i) of all the intercepted frames together, the block change signal indicating changes of the pixel values in block B(m, n) during the L frames.

FIG. 5 shows a plot of the block change signal S(m, n) under different packet loss rates (plrs), wherein the horizontal axis represents the frame sequence and the vertical axis represents the change of the block between one frame and its preceding frame. In FIG. 5, situations where the packet loss rates are 0, 1%, 2%, and 3%, respectively are shown. As can be seen from the figure, the higher the packet loss rate is, the greater the fluctuation of the S(m, n) curve is. Therefore, the fluctuation degree of S(m, n) curve may be used to determine whether or not the image quality of a block is declined due to the packet loss. For example, it is indicated that block B(m, n) has image quality decline when the fluctuation degree of S(m, n) exceeds a predetermined threshold value.

Turning back to FIG. 4, at 404, the fluctuation degree of S(m, n) is determined. The present invention can utilize some technologies well-known in the art to determine the fluctuation degree of the signal S(m, n), an example of which will be described below.

Firstly, the difference between the block change amount S(m, n, i) for frame i and the block change amount S(m, n, i−1) for frame (i−1) is first calculated as DS(m,n,i)=abs(S(m,n,i)−S(m,n,i−1)), i=2, . . . L. The discreteness degree of DS(m,n) over the L intercepted frames can be used to evaluate the fluctuation degree of the signal S(m, n).

Here, the negative effects caused by scene changes described above, if any, should be detected and eliminated. Specifically, suppose frames 0˜(L′−1) are one scene and L′−L are another scene, S (m, n, L′) will be very large and DS (m, n, L′) will be very large too, leading to a great fluctuation in the S(m, n) curve at the number L frame. The fluctuation, however, is caused by the scene change instead of packet losses during transmission. Therefore, the effect of the scene change should be eliminated. It is determined whether or not the pixel block B(m, n) has a scene change at the number i frame. As shown in FIG. 1, however, it is possible that the scene change does not appear in the video stream at all. In this situation, the process for detecting the scene change may be omitted.

In one embodiment, the scene change is detected by detecting outliers is in DS(m, n, i) (i=2, . . . L). The method for detecting outliers may be a method known by those skilled in the art. For example, the average value of all DS(m, n, i) (i=2, . . . L) and the standard deviation from the average value are calculated. When the difference between a data point DS(m, n, i) and the average value is greater than 4 times the standard deviation, the data point is determined as an outlier. An outlier DS (m, n, L′) indicates a scene change at the number L frame. However, this is not a limitation to the method for detecting a scene change, and other methods known by those skilled in the art may also be used.

When it is determined that there is a scene change, the DS(m, n, i) at the ith frame needs to be corrected using the correcting unit 305 in FIG. 3. In one embodiment, correction is made by replacing DS(m, n, L′) with the arithmetic average of DS(m, n, L′−1) of the(L′−1)th frame and DS(m, n, L′+1) of the(L′+1)th frame, i.e. DS(m,n, L′)=0.5×(DS(m,n, L′−1)+DS(m,n, L′+1)). If it is determined that there is no scene change, the process can be omitted.

After the correction, a difference signal DS(m, n) is obtained by pooling all corrected DS(m,n,i) (i=2, . . . L) together. The discreteness degree of DS(m, n) during the L intercepted frames is then calculated to express the fluctuation degree of S(m, n). In an embodiment, the standard deviation std_DS of the signal DS(m, n) is calculated as the discreteness degree of DS(m, n). Although the standard deviation of DS(m, n) is used herein as the discreteness degree, the method for evaluating the discreteness degree of DS(m, n) is not limited to that described above. Any conventional metric for indicating the discreteness degree of values may be applied.

Turning back to FIG. 4, it is determined next whether or not the determined fluctuation degree of S(m, n) exceeds a predetermined threshold value (405). Here, it is to determine whether or not the calculated standard deviation std_DS is greater than a predetermined threshold value std_Corrupt. If it is, the block B(m, n) has image quality decline (406). Otherwise, the block has no image quality decline (407). Then the process ends.

Subsequently, the detecting operation described above is repeated for each of the sampled pixel blocks in order to detect all blocks with image quality decline due to the packet loss during transmission.

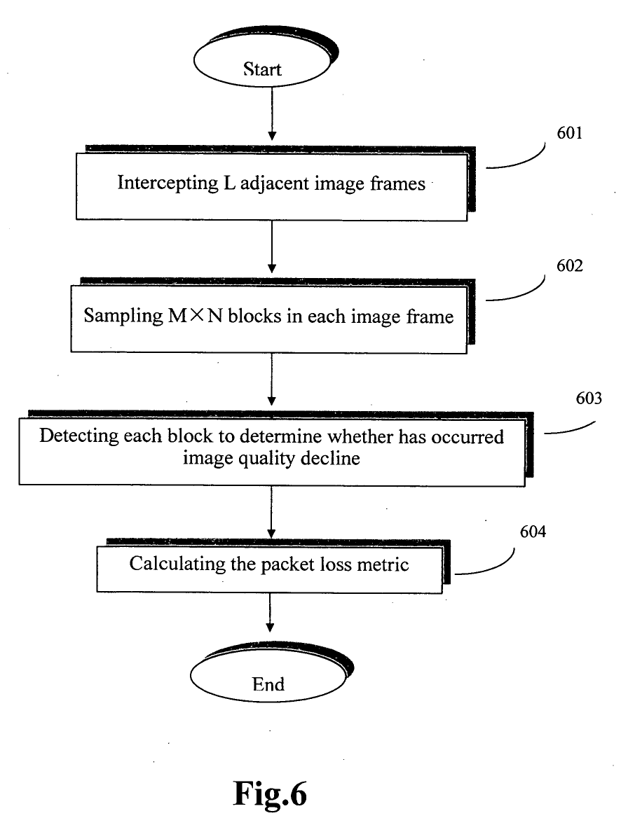

Next, attention turns to FIG. 6, which illustrates a flow chart diagram of a method for calculating packet loss metric for no-reference video quality assessment implemented in accordance with an embodiment of the invention.

First in 601, L adjacent image frames are intercepted from a decoded video stream at the receiving side. Then, pixel blocks located in predetermined positions are sampled from each of the intercepted image frames in 602. As described above, the number and positions of the blocks can be selected by the user and be viewed as a compromise between accuracy and speed. In an embodiment, M×N blocks may be sampled in the form of a matrix for processing. In 603, each of the sampled blocks is detected to determine whether there is image quality decline due to the packet loss in the block. The method for detecting the block having image quality decline due to the packet loss has been described with reference to FIGS. 4 and 5. In 604, the packet loss metric is calculated based on the detecting result in 603. In an embodiment, the packet loss metric is expressed as the ratio of the number of the blocks having quality decline to the total number of the sampled blocks. In the case that M×N blocks arranged in a matrix are sampled, for example, suppose P blocks are detected as experiencing image quality decline, Q=P/MN is calculated as a packet loss metric. Then, the process ends.

The packet loss metric obtained by the system and method according to the present invention is in great consistency with human perception, and can be used to measure packet losses during video transmissions very effectively when the objective NR video quality assessment is performed. The present invention only needs to sample some blocks in an image frame instead of processing the entire frame, thereby reducing the computation greatly and providing a compromise between accuracy and processing speed. Furthermore, the present invention can be suitably applied to real-time video measurement application.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A packet loss metric calculation system for a video stream, comprising:
an intercepting module to intercept a plurality of adjacent image frames in the video stream;
a sampling module to sample a plurality of pixel blocks in predetermined positions in each of the intercepted image frames;
a detecting module to detect the change of each of the sampled blocks over the intercepted image frames to determine whether there is image quality decline in that block; and
a packet loss metric generator to generate the packet loss metric based on detecting result of the detecting module.

2. The system according to claim 1, wherein the detecting module further comprises:
a calculating unit to calculate, for each of the sampled blocks, a block change amount for that block at each of the intercepted frames with respect to its preceding frame;
a pooling unit to pool the block change amounts for the block at all intercepted frames together to obtain a block change signal for the block;
a determining unit for determining fluctuation degree of the block change signal; and
a comparing unit for comparing the fluctuation degree with a predetermined threshold value to determine whether there is image quality decline in the sampled block.

3. The system according to claim 2, wherein the block change amount is related to the sum of the change amounts of respective pixel values in the block.

4. The system of claim 1, wherein the packet loss metric generator further comprises:
a counting module for counting the number of blocks detected by the detecting module as having image quality decline; and
a calculating module for calculating the ratio of the count from the counting module with the number of all the sampled blocks from the sampling module as the packet loss metric.

5. The system according to claim 1, further comprising a scene change detecting module to detect whether or not there is a scene change at each of the intercepted frames.

6. The system according to claim 5, wherein the detecting module further comprises a correcting unit to correct the block change amount at a frame if the scene change is detected at the frame by the scene change detecting module.

7. The system according to claim 1, wherein the size of each of the pixel blocks equals to the size of a macro block defined by the adopted video compression standard, and the position of each pixel block corresponds to a position of a macro block.

8. A packet loss metric calculation method for a video stream, comprising:
intercepting a plurality of adjacent image frames in the video stream;
sampling a plurality of pixel blocks in predetermined positions in each of the intercepted image frames;
detecting the block change of each of the sampled blocks over the intercepted image frames to determine whether there is image quality decline in that block; and
generating the packet loss metric based on the result of the detecting.

9. The method according to claim 8, wherein the detecting step comprising:
calculating, for each of the sampled blocks, a block change amount at each of the intercepted frames with respect to its preceding frame;
pooling the block change amounts for the block at all intercepted frames together to obtain a block change signal for the block;
determining fluctuation degree of the block change signal; and
comparing the fluctuation degree with a predetermined threshold value to determine whether there is image quality decline in the sampled block.

10. The method according to claim 9, wherein the block change amount is related to the sum of the change amounts of respective pixel values in the block.

11. The method according to claim 8, wherein generating the packet loss metric comprising:
counting the number of blocks detected as having image quality decline; and
calculating the ratio of the count from the counting step with the number of all the sampled blocks as the packet loss metric.

12. The method according to claim 8, further comprising detecting whether or not there is a scene change when detecting the change of each of the sampled blocks.

13. The method according to claim 12, further comprising correcting the block change amount at a frame if the scene change is detected at the frame.

14. The method according to claim 8, wherein the size of each pixel block equals to the size of a macro block defined by the adopted video compression standard, and the position of each pixel block corresponds to a position of a macro block.
